(19) United States
(12) Patent Application Publication
(10) Pub. No.: US 2026/0291663 A1
(43) Pub. Date: Sep. 24, 2026

(54) SCHEDULING OF SUCCESSIVE INTERFERENCE CANCELATION CODE BLOCKS WITHIN SPATIALLY COUPLED MULTIPLE-INPUT MULTIPLE-OUTPUT TRANSMISSIONS

(71) Applicant: QUALCOMM Incorporated, San Diego, CA (US)

(72) Inventors: Somsubhra BARIK, SAN DIEGO, CA (US); Jing SUN, San Diego, CA (US); Wei YANG, San Diego, CA (US)

(21) Appl. No.: 19/087,381

(22) Filed: Mar. 21, 2025

(51) Int. Cl. H04L 5/00; H04B 7/0456; H04W 72/1263

(52) U.S. Cl. CPC H04L 5/0023; H04B 7/0456; H04L 5/0055; H04W 72/1263

(57) ABSTRACT

This disclosure provides methods, components, devices and systems for scheduling of successive interference cancelation (SIC) reset code blocks within spatially coupled multiple-input multiple-output (MIMO) transmissions. For example, in spatially coupled MIMO transmissions, reset code blocks may be interspersed with other code blocks (e.g., other code blocks that convey data) to increase the decoding accuracy. The network may indicate, in the scheduling information for the spatially coupled MIMO transmission, an arrangement of the reset code blocks with respect to the data code blocks. For a downlink transmission, the user equipment (UE) may decode the spatially coupled MIMO transmission using SIC decoding in accordance with the reset data blocks. Similarly, for an uplink transmission, the UE may transmit the reset data blocks in the indicated positions such that the network may decode the spatially coupled MIMO transmission using SIC decoding in accordance with the reset data blocks.

### TECHNICAL FIELD

This disclosure relates generally to wireless communication, and more specifically to systems, devices, methods, and techniques associated with scheduling of successive interference cancelation reset code blocks within spatially coupled multiple-input multiple-output transmissions.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a first wireless communication device is described. The method may include communicating, with a second wireless communication device, scheduling information that indicates a set of multiple time-frequency resources and a set of multiple spatial layers for a data communication and transmitting, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

A first wireless communication device for wireless communications is described. The first wireless communication device may include a processing system that includes processor circuitry and memory circuitry that stores code. The processing system may be configured to cause the first wireless communication device to communicate, with a second wireless communication device, scheduling information that indicates a set of multiple time-frequency resources and a set of multiple spatial layers for a data communication and transmit, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

Another first wireless communication device for wireless communications is described. The first wireless communication device may include means for communicating, with a second wireless communication device, scheduling information that indicates a set of multiple time-frequency resources and a set of multiple spatial layers for a data communication and means for transmitting, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

A non-transitory computer-readable medium storing code for wireless communications is described. The code may include instructions executable by one or more processors to communicate, with a second wireless communication device, scheduling information that indicates a set of multiple time-frequency resources and a set of multiple spatial layers for a data communication and transmit, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

Some examples of the method, first wireless communication devices, and non-transitory computer-readable medium described herein may further include operations, features, means, or instructions for receiving, from the second wireless communication device, a negative acknowledgment for a prior transmission of the data communication, where the prior transmission of the data communication used a first density of reset code blocks with respect to data code blocks, where a second density of reset code blocks with respect to data code blocks associated with the arrangement indicated by the scheduling information may be greater than the first density based on reception of the negative acknowledgment.

In some examples of the method, first wireless communication devices, and non-transitory computer-readable medium described herein, transmitting the data communication may include operations, features, means, or instructions for transmitting, based on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second modulation and coding scheme (MCS) for the set of data code blocks that may be increased with respect to a first MCS used for data code blocks of the prior transmission; a fourth MCS for the set of reset code blocks that may be increased with respect to a third MCS used for reset code blocks of the prior transmission; or any combination thereof.

In some examples of the method, first wireless communication devices, and non-transitory computer-readable medium described herein, transmitting the data communication may include operations, features, means, or instructions for transmitting a first subset of reset code blocks of the set of reset code blocks in accordance with a first MCS or a first transmission power level and transmitting a second subset of reset code blocks of the set of reset code blocks in accordance with a second MCS that may be lower than the first MCS or a second transmission power level that may be higher than the first transmission power level, where the second subset of reset code blocks may be each indexed adjacent to multiple data code blocks, and where the first subset of reset code blocks may be each indexed adjacent to a single data code block.

In some examples of the method, first wireless communication devices, and non-transitory computer-readable medium described herein, transmitting the data communication may include operations, features, means, or instructions for transmitting each reset code block of the set of reset code blocks in accordance with a respective MCS, a respective transmission power level, or a combination thereof, that may be based on: a first spacing in data code blocks to a subsequently indexed reset code block, a second spacing in data code blocks to a prior indexed reset code block, or a combination thereof.

In some examples of the method, first wireless communication devices, and non-transitory computer-readable medium described herein, the scheduling information may be indicative of the arrangement via inclusion of a respective density of reset code blocks with respect to data code blocks for one or more subbands of a set of multiple subbands of the set of multiple time-frequency resources.

In some examples of the method, first wireless communication devices, and non-transitory computer-readable medium described herein, the scheduling information may be indicative of the arrangement via inclusion of a respective density of reset code blocks with respect to data code blocks for each symbol of a set of multiple symbols of the set of multiple time-frequency resources.

In some examples of the method, first wireless communication devices, and non-transitory computer-readable medium described herein, the arrangement may be associated with a density of reset code blocks with respect to data code blocks and the density may be based on a channel delay spread associated with a communication channel used to transmit the data communication.

### BRIEF DESCRIPTION OF THE DRAWINGS

FIG. 1 shows an example of a wireless communication system that supports scheduling of successive interference cancelation (SIC) reset code blocks within spatially coupled (SC) multiple-input multiple-output (SC-MIMO) transmissions.

FIG. 2 shows an example of a signaling diagram that supports scheduling of SIC reset code blocks within SC-MIMO transmissions.

FIG. 3 shows an example of a SIC decoding diagram that supports scheduling of SIC reset code blocks within SC-MIMO transmissions.

FIG. 4 shows an example of a multi-layer code block mapping diagram that supports scheduling of SIC reset code blocks within SC-MIMO transmissions.

FIG. 5 shows an example of a code block mapping diagram that supports scheduling of SIC reset code blocks within SC-MIMO transmissions.

FIG. 6 shows examples of code block mapping diagrams within an OFDM symbol that supports scheduling of SIC reset code blocks within SC-MIMO transmissions.

FIG. 7 shows an example of a reset code block density diagram that supports scheduling of SIC reset code blocks within SC-MIMO transmissions.

FIG. 8 shows an example of a SIC decoding diagram that supports scheduling of SIC reset code blocks within SC-MIMO transmissions.

FIG. 9 shows an example of a process flow that supports scheduling of SIC reset code blocks within SC-MIMO transmissions.

FIG. 10 shows a block diagram of a processing system that supports scheduling of SIC reset code blocks within SC-MIMO transmissions.

FIG. 11 shows a diagram of a system including a device that supports scheduling of SIC reset code blocks within SC-MIMO transmissions.

FIG. 12 shows a flowchart illustrating methods that support scheduling of SIC reset code blocks within SC-MIMO transmissions.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, one or more codewords (e.g., user data) may be partitioned into multiple code blocks. A transmitting wireless communication device may communicate the one or more codewords using a multiple-in, multiple-out (MIMO) structure such that code blocks of a codeword are mapped to multiple spatial layers (e.g., communicated using various antenna ports or demodulated reference signal (DMRS) ports of the wireless device) and/or multiple time-frequency resources. For example, a wireless device operating in an NR system may transmit different code blocks of a single codeword over multiple radio-frequency resources in different (e.g., successive or otherwise staggered) time-frequency resources, in some cases using multiple spatial layers in a single time-frequency resource to transmit a same code block or repetitions of a code block. Such a transmission scheme may enable each code block in a transport block to have non-overlapping footprints in frequency and time domain across transmission layers. To decode the code blocks, the receiving wireless communication device may perform successive interference cancellation (SIC) demodulation and decoding, which may involve sequential demapping/demodulating and decoding on a code block by code block basis. As SIC demodulation and decoding is successive, error may propagate, and thus code blocks farther downstream in the SIC process may involve larger demodulation and decoding error. In the SIC process, one or more code blocks that are easiest to decode may be passed through the demodulation and/or decoding operations in the receiving wireless communication device, and subtracted from received signal to facilitate demodulation and/or decoding of subsequent code blocks. For example, the code blocks that are easiest to decode may have a lower modulation and coding scheme than the other code blocks and/or may be transmitted with a higher transmission power level than the other code block to make such code blocks easier to decode successfully. Accordingly, those code blocks that are passed through the demodulation and/or decoding operations may be used to reset SIC process at the receiving wireless communication device, and may be referred to as reset code blocks. As a code block (or a portion of the code block) is further in time from a SIC reset, the decoding accuracy may decrease.

Aspects of the subject matter described in this disclosure relate to interspersing reset code blocks with other code blocks (e.g., other code blocks that convey data) in a spatially coupled (SC) MIMO (SC-MIMO) transmission. In some examples, reset code blocks may also convey data. In some aspects, a serving network entity may indicate, in the scheduling information for the SC-MIMO transmission, an arrangement or pattern of the reset code blocks with respect to the data code blocks. As reset code blocks may also convey data, “data code blocks” as used herein may refer to code blocks that convey data within a transmission that are not reset code blocks. Accordingly, for a downlink transmission where the UE is the receiving device, the UE may decode the SC-MIMO transmission using SIC decoding in accordance with the reset code blocks. Similarly, for an uplink transmission, the UE may transmit the reset code blocks in the indicated positions such that the network may decode the SC-MIMO transmission using SIC decoding in accordance with the reset code blocks. In some examples, the network may indicate a uniform spacing between successive reset code blocks. In some examples, the network may indicate a non-uniform spacing between reset code blocks.

Particular aspects of the subject matter described in this disclosure can be implemented to realize one or more of the following potential advantages. In some examples, by interspersing reset code blocks with data code blocks, the described techniques can be used to improve the decoding accuracy of the data code blocks by reducing the amount of error that propagates in a SIC demodulation and decoding process, as the reset code blocks enable the receiving wireless communication device to reset the SIC demodulation and decoding process (and thus reset the propagated error). By indicating the arrangement or pattern of the reset code blocks of a data communication in scheduling information for the data communication, the transmitting wireless communication device may position the reset code blocks in spatial and time-frequency positions expected by the receiving wireless communication device, enabling the receiving wireless communication device to use the reset code blocks to reset SIC demodulation and decoding procedures, and thus reducing decoding errors. Further by adjusting the transmission power, MCS or density of reset code blocks and/or by implementing non-uniform spacing between reset code blocks, differing decoding conditions in given symbols, subbands or transmission occasions of the SC-MIMO transmission may be accounted for, and thus higher error in symbols, subbands, or transmission occasions with worse decoding conditions may be mitigated.

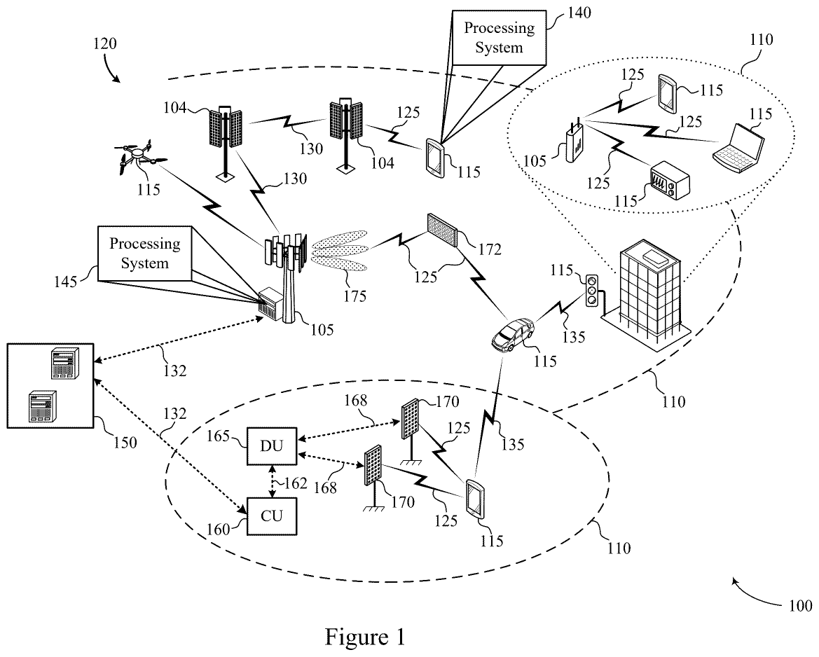

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for scheduling of SIC reset code blocks within SC-MIMO transmissions. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support increased decoding accuracy of SC-MIMO transmissions by interspersing reset code blocks with other code blocks (e.g., code blocks that convey data) in an SC-MIMO transmission. For example, a serving network entity 105 may indicate, in the scheduling information for the SC-MIMO transmission, an arrangement or pattern of the reset code blocks with respect to the data code blocks. Accordingly, for a downlink transmission where the UE 115 is the receiving device, the UE 115 may decode the SC-MIMO transmission using SIC in accordance with the reset code blocks. Similarly, for an uplink transmission, the UE 115 may transmit the reset code blocks in the indicated positions such that the network may decode the SC-MIMO transmission using SIC in accordance with the reset code blocks. In some examples, the network entity 105 may indicate a uniform spacing between successive reset code blocks. In some examples, the network may indicate a non-uniform spacing between reset code blocks. For example, the non-uniform spacing may account for differing channel conditions in given symbols or subbands or for the spacing from a DMRS of the SC-MIMO transmission.

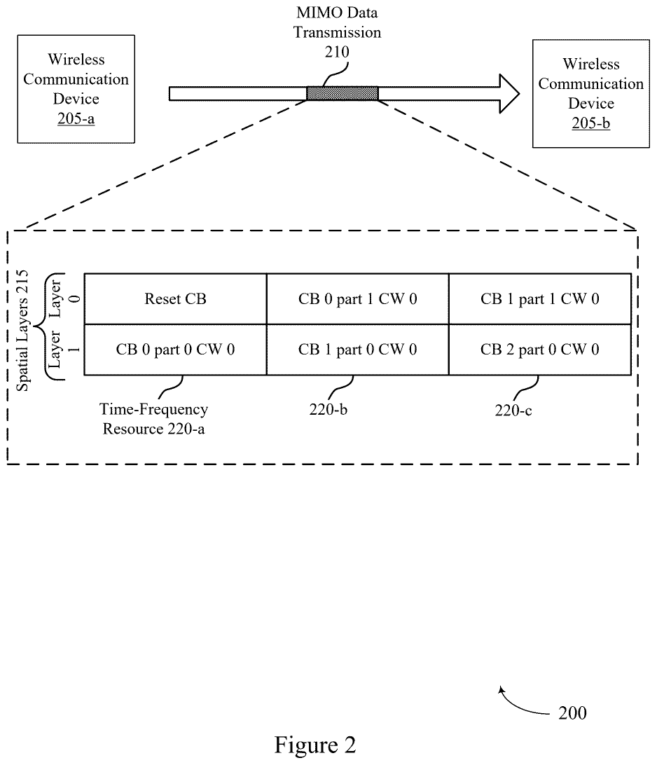

FIG. 2 shows an example of a signaling diagram 200 that supports scheduling of SIC reset code blocks within SC-MIMO transmissions. The signaling diagram 200 may implement or may be implemented by aspects of the wireless communication system 100. For example, the signaling diagram 200 may include a first wireless communication device 205-a and a second wireless communication device 205-b. In some cases, the signaling diagram 200 may depict the first wireless communication device 205-a and the second wireless communication device 205-b communicating a MIMO data transmission 210, which may be an example of data that is communicated using multiple spatial layers 215 via one or more time-frequency resources 220. For example, where the MIMO data transmission 210 is a downlink transmission, the first wireless communication device 205-a may be a network entity 105 as described with reference to FIG. 1 and the second wireless communication device 205-b may be a UE 115 as described with reference to FIG. 1. As another example, where the MIMO data transmission 210 is an uplink transmission, the first wireless communication device 205-a may be a UE 115 as described with reference to FIG. 1 and the second wireless communication device 205-b may be a network entity 105 as described with reference to FIG. 1. As another example, where the MIMO data transmission 210 is an sidelink transmission, the first wireless communication device 205-a and the second wireless communication device 205-b may both be UEs 115 as described with reference to FIG. 1.

The MIMO data transmission 210 may be an SC-MIMO transmission. SC MIMO may be a rate matching feature in which each code block in a TB may have non-overlapping footprints in frequency and time domain the multiple spatial layers 215. For example, SC-MIMO may adopt a D-BLAST layer mapping. As another example, SC-MIMO may be viewed as a layer-specific group (or group of layer specific) staggering code blocks in the time-frequency domain from the transmitting device perspective (e.g., from the perspective of the first wireless communication device 205-a).

For example, the MIMO data transmission 210 may include a codeword (CW0) that is separated into multiple code blocks (CB0, CB1, and CB2 as shown in FIG. 2). The code blocks may be separated into different parts, and the different parts of the code blocks may be transmitted via the different spatial layers of the multiple spatial layers 215. For example, part 0 of CB0 may be transmitted in spatial layer 1 in a first time-frequency resource 220-a (e.g., an OFDM symbol), and part 1 of CB0 may be transmitted in spatial layer 0 in a second time-frequency resource 220-b subsequent to the first time-frequency resource 220-a (e.g., a subsequent OFDM symbol). Similarly, CB1 part 0 may transmitted in spatial layer 1 in the second time-frequency resource 220-b, and part 1 of CB1 may be transmitted in spatial layer 0 in a third time-frequency resource 220-c subsequent to the second time-frequency resource 220-b. CB2 part 0 may be transmitted in spatial layer 0 of the third time-frequency resource 220-c. Although shown as two spatial layers in FIG. 2, higher quantities of layers may be used for SC-MIMO transmissions depending on transmission parameters. For example, an SC-MIMO transmission such as the MIMO data transmission 210 may include a codeword that is separated into code blocks that may be mapped to and transmitted via more than two spatial layers (e.g., three spatial layers, four spatial layers, five spatial layers, etc.). For example, where three spatial layers are used, the CB0 may include three parts, (part 0, part 1, and part 2) mapped to three spatial layers (e.g., CB0 part 0 may be mapped to a time-frequency resource in layer 0, CB0 part 1 may be mapped to a time-frequency resource in layer 1, and CB0 part 2 may be mapped to a time-frequency resource in layer 2). In some examples, an SC-MIMO transmission may include multiple codewords that are separated into multiple respective sets of code blocks, which respective sets of code blocks may be mapped to and transmitted time-frequency resource of the multiple spatial layers.

From the receiving device perspective (e.g., from the perspective of the second wireless communication device 205-b), detection of the MIMO data transmission 210 may involve a sequential demapping, demodulation, and/or decoding on a code block by code block basis, where one or more code blocks that are easiest to decode (which may be referred to as special code blocks or reset code blocks) are passed through the demodulation and/or decoding operations of the receiver and then subtracted from the received signal to facilitate the demodulation and/or decoding of subsequent code blocks. For example, the demodulation and/or decoding operations of the receiver for an SC-MIMO transmission may be similar to successive cancellation decoding (e.g., may implement SIC decoding). As an example, a reset code block may be transmitted in spatial layer 0 in the first time-frequency resource 220-a (the same time-frequency resource as CB0 part 0), and the second wireless communication device 205-b may perform SIC decoding of CB0, CB1, and CB2 based on the reset code block.

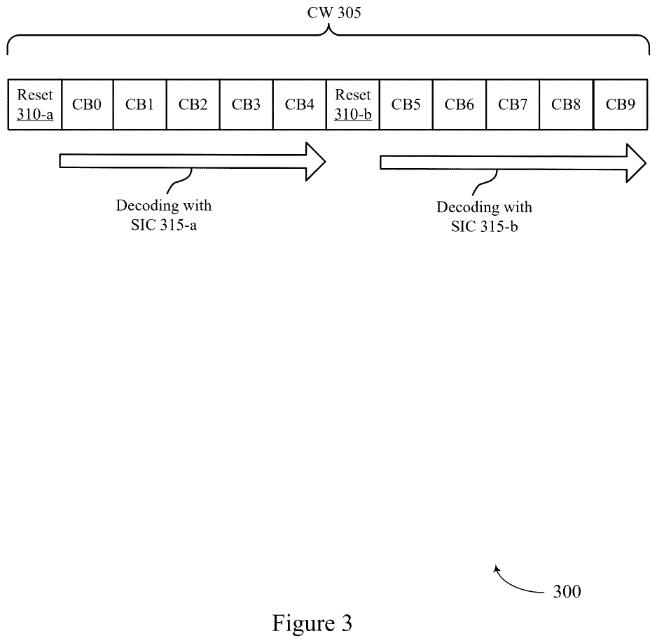

FIG. 3 shows an example of a SIC decoding diagram 300 that supports scheduling of SIC reset code blocks within SC-MIMO transmissions. The SIC decoding diagram 300 may implement or may be implemented by aspects of the wireless communication system 100 or the signaling diagram 200 as described herein. For example, the SIC decoding diagram 300 may show a SIC decoding process for an SC-MIMO transmission (e.g., the MIMO data transmission 210 of FIG. 2) that may be performed by a wireless communication device (such as the second wireless communication device 205-b of FIG. 2) that receives the SC-MIMO transmission.

As described herein, to decode a codeword 305 of an SC-MIMO transmission, a receiving wireless communication device (e.g., the second wireless communication device 205-b of FIG. 2) may pass a reset code block 310 through the demodulation and/or decoding operations and then may perform SIC decoding 315 on subsequent data blocks. For example, the receiving wireless communication device may perform SIC decoding 315-a on CB0 through CB4 after passing the reset code block 310-a through the demodulation and/or decoding operation, and the receiving wireless communication device may perform SIC decoding 315-b on CB5 through CB9 after passing the reset code block 310-a through the demodulation and/or decoding operation.

For large quantities of code blocks in SIC decoding, decoding error may build due to the iterative decoding nature of SIC decoding. Accordingly, the later code blocks may experience lower decoding performance (e.g., due to the built up error). For example, the error in decoding CB0 may affect the decoding of CB1, the error in decoding CB0 and CB1 may affect the decoding of CB2, and so on. In some examples, reset code blocks 310 may be interspersed within the other code blocks of the codeword 305 in order to reset the SIC decoding 315 to reduce the amount of built up error. For example, after the reset code block 310-b, the receiving wireless communication device may restart the SIC decoding 315. In some examples, reset code blocks 310 may be special code blocks with different MCSs and/or different transmission powers than the other code blocks of the codeword 305 or the other code blocks of the SC-MIMO transmission that includes the codeword 305. For example, reset code blocks may convey user data or may not convey user data, but may be transmitted using a higher transmission power than the other code blocks (which may be referred to as data code blocks) or may be transmitted using a lower MCS than the other code blocks. Use of a higher transmission power or a lower MCS may enable the receiving wireless communication to more easily decode the reset code blocks 310 than the other code blocks of the SC-MIMO transmission.

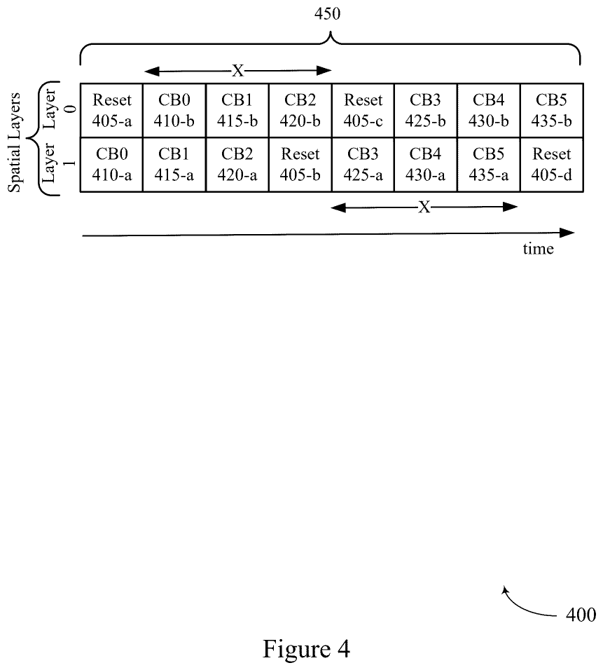

FIG. 4 shows an example of a multi-layer code block mapping diagram 400 that supports scheduling of SIC reset code blocks within SC-MIMO transmissions. The multi-layer code block mapping diagram 400 may implement or may be implemented by aspects of the wireless communication system 100, the signaling diagram 200, or the SIC decoding diagram 300 as described herein. For example, the multi-layer code block mapping diagram 400 may illustrate an example mapping of reset code blocks 405 and other code blocks (e.g., data code blocks) within an SC-MIMO transmission 450 (e.g., which may be an example of a MIMO data transmission 210 as described with reference to FIG. 2).

As described herein, a receiving wireless communication device may use SIC decoding to decode code blocks of the SC-MIMO transmission 450. In some examples, reset code blocks 405 (e.g., which may be examples of reset code blocks 310 as described with reference to FIG. 3) may be included in a time-interspersed manner in the SC-MIMO rate matching to reset the staggering pattern of the code blocks in the SC-MIMO transmission 450. Resetting the staggering pattern of the code blocks enables a receiving wireless communication device to reset a SIC decoding process and therefore to reduce buildup of decoding error associated with SIC decoding.

For example, the SC-MIMO transmission 450 may include a reset code block 405-a in a first time resource (e.g., OFDM symbol) in layer 0 and a first part of CB0 410-a in layer 1 of the first time resource. The SC-MIMO transmission 450 may also include: a second part of CB0 410-b in layer 0 of a second time resource; a first part of CB1 415-a in layer 1 of the second time resource; a second part of CB1 415-b in layer 0 of a third time resource; a first part of CB2 420-a in layer 1 of the third time resource; a second part of CB2 420-b in layer 0 of a fourth time resource; a reset code block 405-b in layer 1 of the fourth time resource; a reset code block 405-c in layer 0 of a fifth time resource; a first part of CB3 425-a in layer 1 of the fifth time resource; a second part of CB3 425-b in layer 0 of a sixth time resource; a first part of CB4 430-a in layer 1 of the sixth time resource; a second part of CB4 430-b in layer 0 of a seventh time resource; a first part of CB5 435-a in layer 1 of the seventh time resource; a second part of CB5 435-b in layer 0 of an eighth time resource; and a reset code block 405-d in layer 1 of the eighth time resource. In some examples, the CB0, the CB1, the CB2, the CB3, the CB4, and the CB5 may be code blocks of a codeword.

As shown, the reset code blocks 405 may be spaced apart from each other by X other code blocks within the SC-MIMO transmission 450. For example, in the example of FIG. 4, X=3. In some examples, the network may indicate in scheduling information for the SC-MIMO transmission 450 a value of X, where X defines the SIC reset period between successive reset code blocks 405 (e.g., in terms of other code blocks). For example, where the SC-MIMO transmission 450 is an uplink transmission (such as a physical uplink shared channel (PUSCH) transmission), the uplink grant (such as a downlink control information (DCI) message or the configured grant (CG) configuration) which schedules the SC-MIMO transmission 450 may indicate a value of X. As another example, where the SC-MIMO transmission 450 is a downlink transmission (such as a physical downlink shared channel (PDSCH) transmission), the scheduling information for the downlink transmission (such as a DCI message or a CG configuration) may indicate a value of X.

In some examples, X may be a fixed quantity for an entirety of the SC-MIMO transmission 450 (e.g., which may imply that reset code blocks 405 are located at uniform spacing along the other code blocks of the SC-MIMO transmission 450). In some examples, X may be non-uniform within the SC-MIMO transmission 450. For example, X may be provided as a sequence of numbers representing non-uniform reset gaps (e.g., which may imply reset code blocks 405 spaced at uneven quantities of other code blocks from each other). For example, a use case for non-uniform spacing of reset code blocks 405 may be when a smaller spacing, X, is demanded to reset SIC decoding more often for the code blocks within symbols with poor channel estimation quality (e.g., in symbols far away from a DMRS particularly in high Doppler scenarios).

Although shown as two spatial layers in FIG. 4, higher quantities of layers may be used for SC-MIMO transmissions depending on transmission parameters. For example, the SC-MIMO transmission 450 may include a codeword that is separated into code blocks that may be mapped to and transmitted via more than two spatial layers (e.g., three spatial layers, four spatial layers, five spatial layers, etc.). In such examples where the SC-MIMO transmission includes more than two spatial layers, reset code blocks 405 may be interspersed with data code blocks and spaced apart from each other via X data code blocks in each of the spatial layers as described herein.

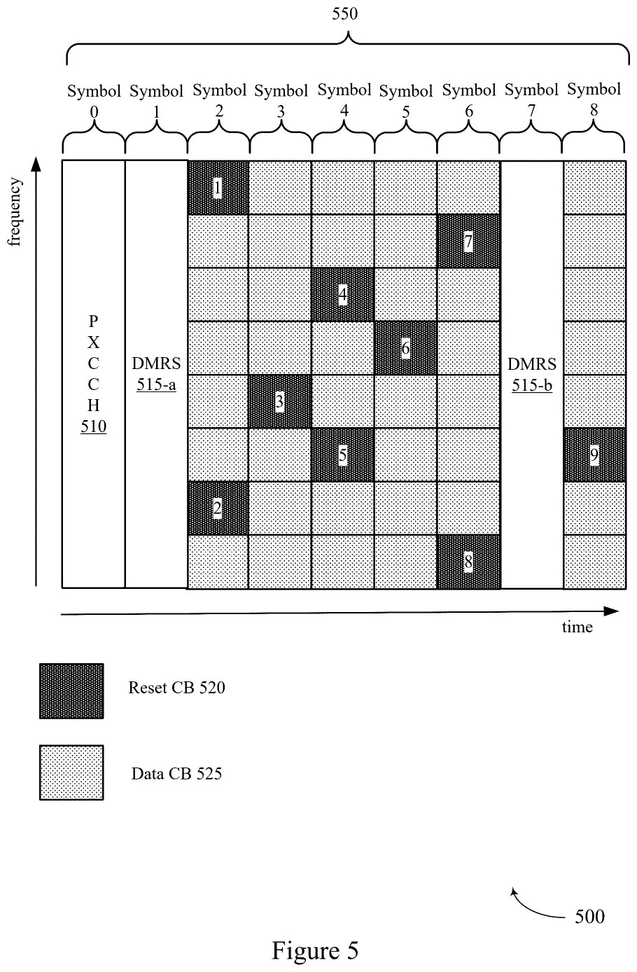

FIG. 5 shows an example of a code block mapping diagram 500 that supports scheduling of SIC reset code blocks within SC-MIMO transmissions. The code block mapping diagram 500 may implement or may be implemented by aspects of the wireless communication system 100, the signaling diagram 200, or the multi-layer code block mapping diagram 400 as described herein. For example, the code block mapping diagram 500 may illustrate an example mapping of reset code blocks 520 and data code blocks 525 within an SC-MIMO transmission 550 (e.g., which may be an example of a MIMO data transmission 210 as described with reference to FIG. 2 or an SC-MIMO transmission 450 as described with reference to FIG. 4).

As described herein, in some examples, an SC-MIMO transmission 550 may implement non-uniform spacing between reset code blocks 520 (e.g., which may be reset code blocks 405 as described with reference to FIG. 4). In some examples, the SC-MIMO transmission 550 may be transmitted via multiple OFDM symbols (shown as symbols 0 through 8). In symbol 0, the SC-MIMO transmission 550 may include a control channel transmission 510 (e.g., a physical downlink control channel (PDCCH) transmission in downlink or a physical uplink control channel (PUCCH) transmission in uplink). Symbol 1 may include a first DMRS 515-a, and symbol 7 may include a second DMRS 515-b. The receiving wireless communication device may use the DMRSs 515 to estimate the channel via which the SC-MIMO transmission 550 in order to decode the code blocks (e.g., the reset code blocks 520 and the data code blocks 525) of the SC-MIMO transmission. For example, use data may be transmitted in code blocks of symbols 2, 3, 4, 5, 6, and 8.

In the SC-MIMO transmission 550, the data blocks within symbol 4 may be expected to experience the highest channel error (e.g., based on mean squared error (MSE)) due to interpolation error (e.g., at medium to high Doppler levels) due to the distance in time from the symbols which include the DMRSs 515. For example, symbols 2, 6, and 8 are one OFDM symbol away from a DMRS 515, symbols 3 and 5 are two OFDM symbols away from a DMRS 515, and symbol 4 is three OFDM symbols away from a DMRS 515. Thus, channel estimation may be worse for symbol 4 than symbols 2, 3, 5, 6, and 8. As symbol 4 may be expected to have worse channel estimation at the receiving wireless communication device than symbols 2, 3, 5, 6, and 8, the network may increase the density of reset code blocks 520 within symbol 4 as compared to symbols 2, 3, 5, 6, and 8. For example, the reset gap length (e.g., the spacing X between reset code blocks 520 in terms of data code blocks 525) may be “5” in symbols 2, 3, 5, 6, and 8 and may be “2” in symbol 4.

In some examples, to indicate in scheduling information the code block gaps for the different symbols of the SC-MIMO transmission 550, the scheduling information may express the reset code block gaps as a sequence of integers indicating the gap values (e.g., as a function of the DMRS symbol pattern for the SC-MIMO transmission 550). For example, to express that the reset gap length may be “5” in symbols 2, 3, 5, 6, and 8 and may be “2” in symbol 4 as shown in FIG. 5, a sequence {5,5,5,2,5,5,5,5} may be provided.

In some examples, gap values may be expressed explicitly, (e.g., X={X₁, X₁ . . . , X₂, X₂, . . . , Xₘ, Xₘ, . . . } where each index indicates a reset period and each entry is the reset gap length). For example, a reset period may correspond to a period between two subsequent reset code blocks 520. For example, {5,5,5,2,5,5,5,5} indicates five data code blocks 525 between the first reset code block 520 and the second reset code block 520, five data code blocks 525 between the second reset code block 520 and the third reset code block 520, five data code blocks 525 between the third reset code block 520 and the fourth reset code block 520, two data code blocks 525 between the fourth reset code block 520 and the fifth reset code block 520, five data code blocks 525 between the fifth reset code block 520 and the sixth reset code block 520, five data code blocks 525 between the sixth reset code block 520 and the seventh reset code block 520, five data code blocks 525 between the seventh reset code block 520 and the eighth reset code block 520, and five data code blocks 525 between the eighth reset code block 520 and the ninth reset code block 520. In some examples, gap values may be expressed as a sequence of tuples {(X₁,N_{X}_{₁}), (X₂,N_{X}_{₂}), . . . , (Xₘ,N_{X}_{ₘ})} where N_{X}_{ₘ} indicates the number of reset periods with the gap length Xₖ. In some examples, a reset code block density boost or gap period backoff may be indicated by communication in the scheduling information of a fixed delta or sequence of deltas to original X value (e.g., Xₖ=X₁−Δₖ, for all k). In some examples, a reset code block density boost or gap period backoff may be indicated by communication in the scheduling information of an explicit indication of each unique X value.

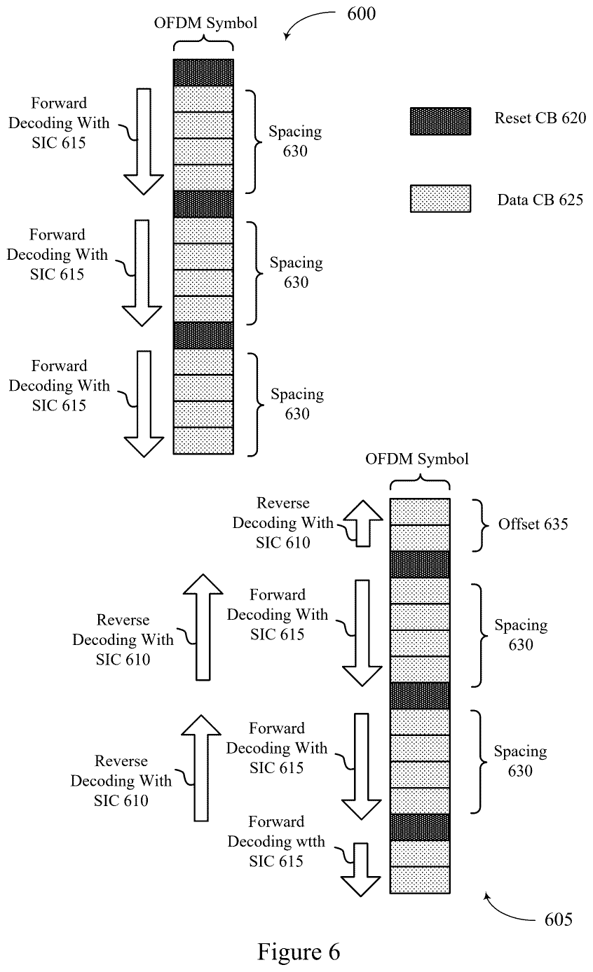

FIG. 6 shows an example of a code block mapping diagram 600 within an OFDM symbol and a code block mapping diagram 605 within an OFDM symbol that supports scheduling of SIC reset code blocks within SC-MIMO transmissions. The code block mapping diagram 600 and the code block mapping diagram 605 may implement or may be implemented by aspects of the wireless communication system 100, the signaling diagram 200, the multi-layer code block mapping diagram 400, or the code block mapping diagram 500 as described herein. For example, the code block mapping diagram 600 and the code block mapping diagram 605 may illustrate example spacings of reset code blocks 620 with respect to data code blocks 620 for an SC-MIMO transmission (e.g., a MIMO data transmission 210 as described with reference to FIG. 2, an SC-MIMO transmission 450 of FIG. 4, or an SC-MIMO transmission 550 of FIG. 5) within an OFDM symbol.

As described herein, in some examples, an SC-MIMO transmission (such as the SC-MIMO transmission 450 of FIG. 4 or the SC-MIMO transmission 550 of FIG. 5) may implement non-uniform spacing between reset code blocks 620 (e.g., which may be reset code blocks 405 as described with reference to FIG. 4 or reset code blocks 520 of FIG. 5). In some examples, scheduling information for an SC-MIMO transmission may indicate the reset code block spacing (e.g., in terms of data code blocks) on an OFDM symbol basis for the OFDM symbols within the SC-MIMO transmission. For example, the scheduling information may define a reset code block spacing or density within the context of an OFDM symbol (e.g., for code blocks partially or fully overlapping with the given symbol) instead of global slot-wise reset code blocks spacings or density values that apply to multiple symbols within the SC-MIMO transmission.

For example, the scheduling information may indicate the reset code block spacing 630 for each OFDM symbol of an SC-MIMO transmission. In such examples, the network may assign more dense reset code blocks 620 to OFDM symbols with worse channel estimation (e.g., with reference to FIG. 5, symbol 4 may be provided a more dense reset code block spacing than symbols 2, 3, 5, 6, and 8).

In some examples, as shown in the code block mapping diagram 600, a first code block fully overlapping with a given OFDM symbol may be designated as the first reset code block within the given OFDM symbol, and a remainder of the reset code blocks within the given OFDM symbol may be spaced with reference to the first code block according to the indicated reset code block spacing 630 (e.g., provided as XSymId within the scheduling information). As described herein, the reset code block spacing 630 may refer to the quantity of data code blocks 625 between reset code blocks 620. In some examples, the first code block fully overlapping with a given OFDM symbol may be designated as the first reset code block within the given OFDM symbol in cases where the receiving wireless communication device implements one-directional SIC decoding (e.g., forward SIC decoding 615).

In some examples, as shown in the code block mapping diagram 605, the scheduling information may provide an offset value 635 and a spacing value for a given OFDM symbol (e.g., an offset value 635 and a spacing value may be provided on an OFDM-symbol wise basis). For example, the offset value 635 may indicate the position of the first reset code block within a given OFDM symbol with respect to the first code block fully overlapping with a given OFDM symbol. The scheduling information may provide an offset value 635 and a spacing value for a given OFDM symbol in cases where the receiving wireless communication device implements bi-directional SIC decoding (e.g., the receiving wireless communication device implements forward SIC decoding 615 and reverse SIC decoding 610).

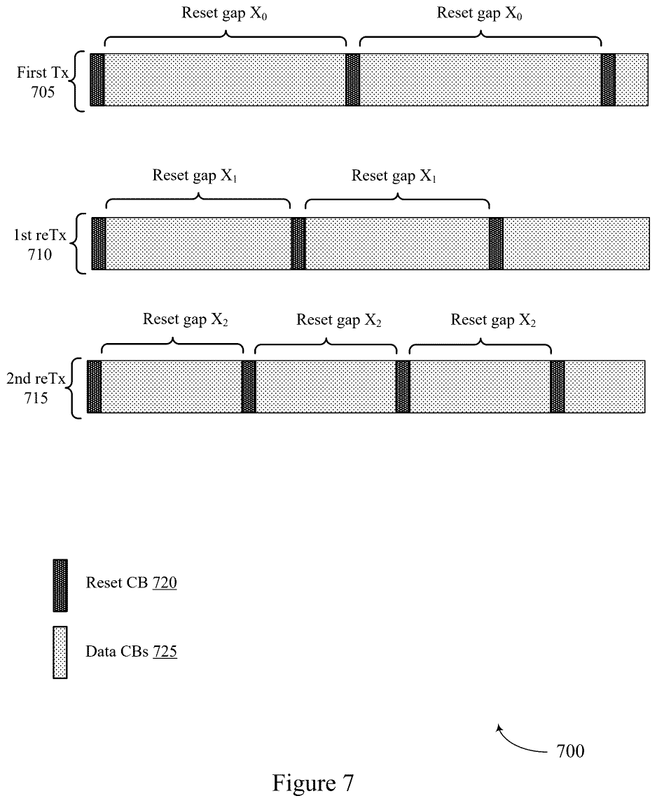

FIG. 7 shows an example of a reset code block density diagram 700 that supports scheduling of SIC reset code blocks within SC-MIMO transmissions. The reset code block density diagram 700 may implement or may be implemented by aspects of the wireless communication system 100, the signaling diagram 200, the multi-layer code block mapping diagram 400, the code block mapping diagram 500, the code block mapping diagram 605, or the code block mapping diagram 605, as described herein. For example, the reset code block density diagram 700 may illustrate adjustments to spacings between reset code blocks of subsequent retransmissions of SC-MIMO transmissions (e.g., a MIMO data transmission 210 as described with reference to FIG. 2, an SC-MIMO transmission 450 of FIG. 4, or an SC-MIMO transmission 550 of FIG. 5).

In some examples, the receiving wireless communication device (e.g., the second wireless communication device 205-b of FIG. 2) may transmit a negative acknowledgment (NACK) to the transmitting wireless communication device (e.g., the first wireless communication device 205-a of FIG. 2) for an SC-MIMO transmission 705 if the receiving wireless communication device does not successfully decode one or more code blocks of the SC-MIMO transmission 705. In such examples, the transmitting wireless communication device may transmit a first retransmission 710 of the SC-MIMO transmission in response to the NACK. In some examples, the receiving wireless communication device may transmit a second NACK for the first retransmission 710 of the SC-MIMO transmission if the receiving wireless communication device does not successfully decode one or more code blocks of the first retransmission 710 of the SC-MIMO transmission. In such examples, the transmitting wireless communication device may transmit a second retransmission 715 of the SC-MIMO transmission in response to the second NACK.

In some examples, the network may adjust the reset code block gap X based on such HARQ feedback. For example, the network may indicate a first reset code block gap X₀ for the first transmission of the SC-MIMO transmission 705, and may iteratively decrease X in each subsequent retransmission of the SC-MIMO transmission to increase the probability the receiving wireless communication device can successfully decode the code blocks of the SC-MIMO transmission. For example, as shown in FIG. 7, the first transmission of the SC-MIMO transmission 705 may use a reset gap of X₀ data code blocks 725 between reset data code blocks 720, the first retransmission 710 of the SC-MIMO transmission may use a reset gap of X₁ data code blocks 725 between reset data code blocks 720 (where X₀>X₁), and the second retransmission 715 of the SC-MIMO transmission may use a reset gap of X₂ data code blocks 725 between reset data code blocks 720 (where X₁>X₂).

In some examples, starting with an initial reset gap X₀ (which may be a default reset gap value) between reset code blocks, the value of X may be decreased by a fixed delta, ΔX, for each successive retransmission of the SC-MIMO transmission (e.g., Xᵢ for ith reTx is X₀−i*Δ_{S}, i=0,1,2,3). For example, the fixed delta may be signaled by the network (e.g., in the scheduling information that indicates or configures X₀). In some examples, Xᵢ for the ith retransmission, i=1,2,3, may be explicitly signaled by the network (e.g., in the scheduling information that indicates or configures X₀).

For example, in cases where the reset code blocks 720 convey known or no data, the Phy level scheduler may be able to allocate additional time and/or frequency resources to accommodate extra reset code blocks as compared to a prior transmission or retransmission. For example, the reset code blocks 720 may convey data that is known at the receiving wireless communication device prior to transmission such that the receiving wireless communication device may verify the decoding accuracy of the reset code blocks 720. In such cases where the reset code blocks 720 convey known or no data and the Phy level scheduler may be able to allocate additional time and/or frequency resources to accommodate extra reset code blocks, the extra reset code blocks may be rate matched to additional channel resources.

In some cases, however, the Phy level scheduler may not be able to allocate additional resources to accommodate extra reset code blocks, in which case the amount of time-frequency-spatial resources to rate match across the first transmission and the retransmissions may be constant. In some examples, where the quantity of reset code blocks 720 across HARQ retransmissions changes and there are no additional time-frequency-spatial resources in subsequent HARQ retransmissions (e.g., the first transmission of the SC-MIMO transmission 705, the first retransmission 710 of the SC-MIMO transmission, and the second retransmission 715 of the SC-MIMO transmission are all allocated the same quantity of time-frequency-spatial resources), one or more techniques may be implemented to accommodate the additional reset code blocks 720 in subsequent HARQ retransmissions. In a first technique, a higher puncturing rate may be used in the subsequent HARQ retransmissions for data code blocks 725, for reset code blocks 720, or both. In a second technique, a higher modulation order and/or coding rate may be configured and used for some or all of the data code blocks 725 in subsequent HARQ retransmissions. In a third technique, higher modulation order and/or coding rate may be configured and used for some or all of the reset code blocks 720 in subsequent HARQ retransmissions (which may have a smaller impact on the overall ability of the receiving wireless communication device to decode the subsequent HARQ retransmissions as there may be fewer reset code blocks 720 than data code blocks 725). In a fourth technique, a weighted combination of the second and third techniques may be implemented. In some examples, in the fourth technique, the weight of the higher modulation order and/or coding rate applied to data code blocks 725 as compared to the higher modulation order and/or coding rate applied to reset code blocks 720 may be based on the initial value of X (e.g., the ratio of data code blocks 725 to reset code blocks 720.

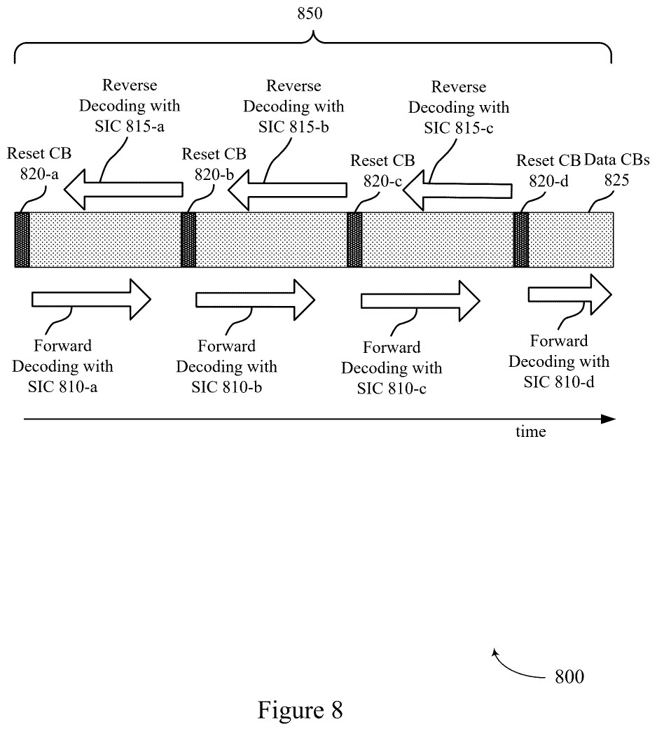

FIG. 8 shows an example of a SIC decoding diagram 800 that supports scheduling of SIC reset code blocks within SC-MIMO transmissions. The SIC decoding diagram 800 may implement or may be implemented by aspects of the wireless communication system 100, the signaling diagram 200, the SIC decoding diagram 300, the multi-layer code block mapping diagram 400, or the code block mapping diagram 500, the code block mapping diagram 605, or the code block mapping diagram 605, as described herein as described herein. For example, the SIC decoding diagram 800 may show a SIC decoding process for an SC-MIMO transmission 850 (e.g., e.g., a MIMO data transmission 210 as described with reference to FIG. 2, an SC-MIMO transmission 450 of FIG. 4, or an SC-MIMO transmission 550 of FIG. 5) that may be performed by a wireless communication device (such as the second wireless communication device 205-b of FIG. 2) that receives the SC-MIMO transmission.

As described herein, a receiving wireless communication device may use SIC decoding to decode code blocks of the SC-MIMO transmission 850. In some examples, reset code blocks 820 may be interspersed with data code blocks 825 in the SC-MIMO transmission 85. The reset code blocks may enable the receiving wireless communication device to reset a SIC decoding processes. In some examples, the receiving wireless communication device may implement bidirectional SIC decoding. For example, the receiving wireless communication device may perform forward SIC decoding 810 from reset code blocks 820 and backward SIC decoding 815 from reset code blocks 820 to boost the probability of successfully decoding the data code blocks 825. For example, a data code block adjacent to the reset code block 820-b and between the reset code blocks 820-a and the reset code block 820-b may fail the forward SIC decoding 810-a but may pass the backward SIC decoding 815-a. Similarly, a data code block adjacent to the reset code block 820-b and between the reset code blocks 820-band the reset code block 820-c may pass the forward SIC decoding 810-b but may fail the backward SIC decoding 815-b. Similarly, a data code block adjacent to the reset code block 820-c and between the reset code blocks 820-c and the reset code block 820-d may pass the forward SIC decoding 810-c but may fail the backward SIC decoding 815-c. In some examples, the reset code block 820-d may not be an edge code block for the SC-MIMO transmission 850 (e.g., data code blocks 825 may follow the reset code block 820-d in time and the receiving wireless communication device may perform forward SIC decoding 810-d to decode the data code blocks 825 that follow the reset code block 820-d in time). In some examples, the reset code block 820-d may be an edge code block (e.g., no other data code blocks may follow the reset code block 820-d in time within the SC-MIMO transmission 850).

In some examples, depending on the location or position within the SC-MIMO transmission 850, all or only a subset of reset code blocks 820 may be responsible for starting SIC decoding in both directions, and/or a subset of reset code blocks 820 may be responsible for starting SIC decoding in a single direction. For example, the reset code block 820-a may only start SIC decoding in the forward direction, while the reset code block 820-b, the reset code block 820-c, and the reset code block 820-d may start SIC decoding in both directions. In some examples, the network may favor the reset code blocks associated with starting SIC decoding in both directions (e.g., as successful decoding of a larger quantity of data code blocks 825 may be dependent on decoding of such reset code blocks 820 associated with starting SIC decoding in both directions than reset code blocks 820 associated with starting SIC decoding in a single direction).

For example, reset code blocks 820 may be favored by the network depending on the indexing of the reset code blocks 820 within a TB, with those reset code blocks 820 in the middle of the sequence of code blocks (such as the reset code block 820-b and the reset code block 820-c) receiving a higher priority (e.g., lower payload) compared to reset code blocks 820 in the edge of the TB (such as the reset code block 820-a and the reset code block 820-d). For example, reset code blocks 820 in the middle of the TB may be associated with successful decoding of a larger quantity of data code blocks 825 than reset code blocks 820 at the edge of the TB. In some examples, the network may configure (e.g., indicate in scheduling information) a higher MCS to the less favored reset code blocks 820 (e.g., the edge reset code blocks 820) and a lower MCS to the favored reset code blocks 820 (e.g., the middle reset code blocks 820). In some examples, the MCS backoff for the favored reset code blocks may be proportional to the quantity of data code blocks 825 in the gap between each set of adjacent reset code blocks 820. In some examples, the network may configure (e.g., indicate in scheduling information) the transmitting wireless communication device to transmit the less favored reset code blocks 820 (e.g., the edge reset code blocks 820) with a lower transmission power and the favored reset code blocks 820 (e.g., the middle reset code blocks 820) with a higher transmission power. In some examples, power backoff for the less favored reset code blocks 820 may be proportional to the quantity of data code blocks 825 in the gap between each set of adjacent reset code blocks 820. For example, the reset code block 820-d may have fewer data code blocks after the reset code block 820-d in time until the end of the TB than the reset code block 820-c has between the reset code block 820-c and the reset code block 820-d, and accordingly the reset code block 820-c may be configured with a lower MCS or a higher transmission power than the reset code block 820-d.

In some examples, SC-MIMO may have higher performance gains in FDD bands than TDD due to higher non-orthogonality among layers. At these bands, the benefits of massive MIMO (mMIMO) beamforming may be limited, which may leave the channel as moderately frequency selective. The network may use the knowledge of channel selectivity to determine a value of X (e.g., the spacing between subsequent reset code blocks in terms of data code blocks). In some examples, the network may select a value of X as a function of the channel delay spread. For example, the network may select values of X based on delay spread ranges defined by thresholds DS₁, DS₂, . . . such that X=X₁ when DS<DS₁, X=X₂ (<X₁) if DS₁<DS<DS₂and so on. {X₁, X₂, . . . } and {DS0, DS1, . . . } may be configured via control signaling such as RRC.

In some examples, in scenarios where a UE 115 experiences subband interference patterns (e.g., frequency spur due to RF, unmitigated MU-MIMO interference known at network entity 105), the network may benefit from careful placement of reset code blocks in the frequency domain around those bands of high interference. For example, due to potential degradation of signal quality in these bands, the SC-MIMO pipeline may demand more frequent resetting. Accordingly, in some examples, the network may assign a different reset code block density value X P (<X) to reset code blocks within one or more subbands that experience poor signal quality due to interference. For example, the network may define a same X P for all OFDM symbols in the slot for time-invariant interference pattern, or define symbol-wise X P for time-varying patterns. In some examples, the network may specify such subbands via indicating the start and end code block indices to the UE 115 (which could be the transmitting wireless communication device or the receiving wireless communication device) either semi-statically or through dynamic signaling. A different reset CB density value X′ may not be applied in subbands that overlap a single code block.

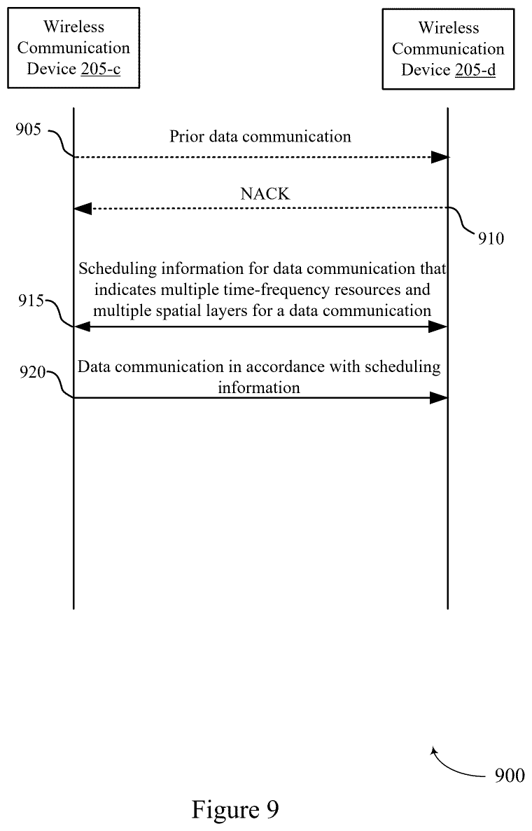

FIG. 9 shows an example of a process flow 900 that supports scheduling of SIC reset code blocks within SC-MIMO transmissions. The process flow 900 may implement or may be implemented by aspects of the wireless communication system 100 or the signaling diagram 200 as described herein. For example, the process flow 900 includes a first wireless communication device 205-c and a second wireless communication device 205-d, which may be examples of wireless communication devices 205 as described herein. In the following description of the process flow 900, the communications between the first wireless communication device 205-c and the second wireless communication device 205-d may be transmitted in a different order than the example order shown, or the operations performed by the first wireless communication device 205-c and the second wireless communication device 205-d may be performed in different orders or at different times. Some operations may also be omitted from the process flow 900, and other operations may be added to the process flow 900.

At 915, the first wireless communication device 205-c may communicate, with the second wireless communication device 205-d, scheduling information that indicates a set of multiple time-frequency resources and a set of multiple spatial layers for a data communication. For example, in an uplink scenario, the first wireless communication device 205-c may be a UE 115 that receives the scheduling information from the network entity 105. As another example, in a downlink scenario, the first wireless communication device 205-c may be a network entity 105 that transmits the scheduling information from the network entity 105. In some examples, the scheduling information may be conveyed via DCI (e.g., for a dynamically scheduled data communication). In some examples, the data communication may be periodic or semi-statically scheduled. For example, the scheduling information may be conveyed via an RRC configuration.

At 920, the first wireless communication device 205-c may transmit, to the second wireless communication device 205-d, the data communication in accordance with the scheduling information. The data communication may include a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers. The data communication may include a set of reset code blocks that are each indicative of a respective time-frequency resource associated with resetting of a successive interference cancellation and decoding procedure for the data communication. The scheduling information may be indicative of an arrangement of the set of reset code blocks with respect to the set of data code blocks within the set of multiple time-frequency resources and the set of multiple spatial layers. In some examples, the data communication may include multiple codewords that each include multiple code blocks, and each of the multiple code blocks may be transmitted in different time-frequency resources of the set of multiple time-frequency resources and in different spatial layers of the set of multiple spatial layers. In some examples, each code block may be transmitted in more than two code block portions that are each transmitted in different spatial layers (e.g., three code block portions in three different respective spatial layers, four code block portions in four different respective spatial layers, etc.) In some examples, each code block may be transmitted in two code block portions mapped to two different spatial layers of more than two possible spatial layers (e.g., the transmission may use four spatial layers, and each code block may be separated into two code block parts mapped to two of the four spatial layers).

In some examples, at 905 the first wireless communication device 205-c may transmit, to the second wireless communication device 205-d, a prior transmission of the data communication using a first density of reset code blocks with respect to data code blocks. In some such examples, at 910, the first wireless communication device 205-c may receive, from the second wireless communication device 205-d, a NACK for the prior transmission, and the transmission at 920 may be a retransmission of the data communication. The second density of the transmission at 920 of reset code blocks with respect to data code blocks associated with the arrangement indicated by the scheduling information may be greater than the first density based on reception of the NACK (e.g., densities may be increased for retransmissions to increase the decoding probability of the retransmissions). In some examples, transmitting the data communication at 920 includes transmitting, based on the prior transmission of the data communication using a first quantity of time-frequency-spatial resources, the data communication using a second quantity of time-frequency-spatial resources. In some such examples, the first quantity of time-frequency-spatial resources may be equal to or greater than the second quantity of time-frequency-spatial resources. In some such examples, the data communication may be transmitted in accordance with: a first puncturing rate for the set of data code blocks; a second puncturing rate for the set of reset code blocks; a second MCS for the set of data code blocks that is increased with respect to a first MCS used for data code blocks of the prior transmission; a fourth MCS for the set of reset code blocks that is increased with respect to a third MCS used for reset code blocks of the prior transmission; or any combination thereof.

In some examples, transmitting the data communication at 920 includes transmitting a first subset of reset code blocks of the set of reset code blocks in accordance with a first MCS or a first transmission power level; and transmitting a second subset of reset code blocks of the set of reset code blocks in accordance with a second MCS that is lower than the first MCS or a second transmission power level that is higher than the first transmission power level, where the second subset of reset code blocks are each indexed adjacent to multiple data code blocks, and where the first subset of reset code blocks are each indexed adjacent to a single data code block. For example, the MCS or transmission power level applied to each reset code blocks may be based on the quantity of data blocks surrounding each reset code block.

In some examples, transmitting the data communication at 920 includes transmitting each reset code block of the set of reset code blocks in accordance with a respective MCS, a respective transmission power level, or a combination thereof, that is based on: a first spacing in data code blocks to a subsequently indexed reset code block, a second spacing in data code blocks to a prior indexed reset code block, or a combination thereof.

In some examples, the scheduling information at 915 may be indicative of the arrangement via inclusion of an indication of a periodicity of reset code blocks with respect to data code blocks, and the periodicity may be based on a spacing in data code blocks between successive reset code blocks of the set of reset code blocks.

In some examples, the scheduling information at 915 may be indicative of the arrangement via inclusion of an indication of respective spacings in data code blocks between successive reset code blocks of the set of reset code blocks. In some examples, the indication of respective spacing may include a sequence of integers indicative of the respective spacings. In some examples, the indication of respective spacing may include a set of tuples, where for each tuple of the set of tuples a respective first value indicates a respective spacing size in data code blocks and a respective second value indicates a quantity of consecutive spacings between successive reset code blocks having the respective spacing size. In some examples, the scheduling information may indicate the respective spacings with respect to a reference spacing value

In some examples, the scheduling information at 915 may be indicative of the arrangement via inclusion of a respective density of reset code blocks with respect to data code blocks for one or more subbands of a set of multiple subbands of the set of multiple time-frequency resources.

In some examples, the scheduling information at 915 may be indicative of the arrangement via inclusion of a respective density of reset code blocks with respect to data code blocks for each symbol of a set of multiple symbols of the set of multiple time-frequency resources.

In some examples, the arrangement may be associated with a density of reset code blocks with respect to data code blocks, and the density may be based on a channel delay spread associated with a communication channel used to transmit the data communication.

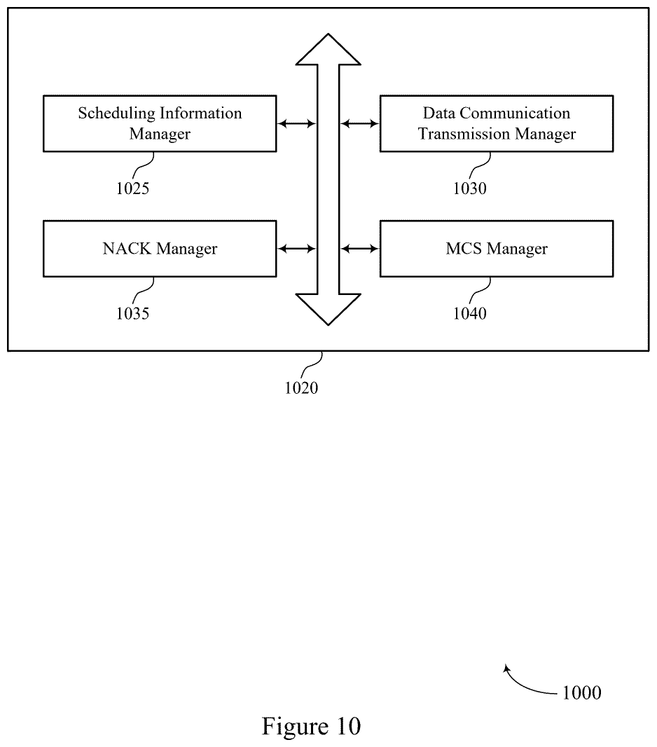

FIG. 10 shows an example of a processing system 1020 that supports scheduling of SIC reset code blocks within SC-MIMO transmissions. A processing system 1020 may be an example of a processing system 140 (such as of a UE 115) and may include a scheduling information manager 1025, a data communication transmission manager 1030, a NACK manager 1035, an MCS manager 1040, or any combination thereof. A processing system 1020, or various component thereof, may be an example of means for performing (such as a means for causing a UE 115 to perform) various techniques described herein.

The scheduling information manager 1025 may be configured to cause the UE 115 to communicate, with a second wireless communication device, scheduling information that indicates a set of multiple time-frequency resources and a set of multiple spatial layers for a data communication. The data communication transmission manager 1030 may be configured to cause the UE 115 to transmit, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

In some examples, the NACK manager 1035 may be configured to cause the UE 115 to receive, from the second wireless communication device, a negative acknowledgment for a prior transmission of the data communication, where the prior transmission of the data communication used a first density of reset code blocks with respect to data code blocks, where a second density of reset code blocks with respect to data code blocks associated with the arrangement indicated by the scheduling information is greater than the first density based on reception of the negative acknowledgment.

In some examples, to support transmitting the data communication, the data communication transmission manager 1030 may be configured to cause the UE 115 to transmit, based on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second MCS for the set of data code blocks that is increased with respect to a first MCS used for data code blocks of the prior transmission; a fourth MCS for the set of reset code blocks that is increased with respect to a third MCS used for reset code blocks of the prior transmission; or any combination thereof.

In some examples, to support transmitting the data communication, the data communication transmission manager 1030 may be configured to cause the UE 115 to transmit a first subset of reset code blocks of the set of reset code blocks in accordance with a first MCS or a first transmission power level. In some examples, to support transmitting the data communication, the data communication transmission manager 1030 may be configured to cause the UE 115 to transmit a second subset of reset code blocks of the set of reset code blocks in accordance with a second MCS that is lower than the first MCS or a second transmission power level that is higher than the first transmission power level, where the second subset of reset code blocks are each indexed adjacent to multiple data code blocks, and where the first subset of reset code blocks are each indexed adjacent to a single data code block.

In some examples, to support transmitting the data communication, the MCS manager 1040 may be configured to cause the UE 115 to transmit each reset code block of the set of reset code blocks in accordance with a respective MCS, a respective transmission power level, or a combination thereof, that is based on: a first spacing in data code blocks to a subsequently indexed reset code block, a second spacing in data code blocks to a prior indexed reset code block, or a combination thereof.

In some examples, the scheduling information is indicative of the arrangement via inclusion of an indication of a periodicity of reset code blocks with respect to data code blocks. In some examples, the periodicity is based on a spacing in data code blocks between successive reset code blocks of the set of reset code blocks.

In some examples, the scheduling information is indicative of the arrangement via inclusion of an indication of respective spacings in data code blocks between successive reset code blocks of the set of reset code blocks.

In some examples, the indication of respective spacing includes a sequence of integers indicative of the respective spacings.

In some examples, the indication of respective spacing includes a set of tuples. In some examples, for each tuple of the set of tuples a respective first value indicates a respective spacing size in data code blocks and a respective second value indicates a quantity of consecutive spacings between successive reset code blocks having the respective spacing size.

In some examples, the scheduling information indicates the respective spacings with respect to a reference spacing value.

In some examples, the scheduling information is indicative of the arrangement via inclusion of a respective density of reset code blocks with respect to data code blocks for one or more subbands of a set of multiple subbands of the set of multiple time-frequency resources.

In some examples, the scheduling information is indicative of the arrangement via inclusion of a respective density of reset code blocks with respect to data code blocks for each symbol of a set of multiple symbols of the set of multiple time-frequency resources.

In some examples, the arrangement is associated with a density of reset code blocks with respect to data code blocks. In some examples, the density is based on a channel delay spread associated with a communication channel used to transmit the data communication.

In some examples, to support communicating the scheduling information, the data communication transmission manager 1030 may be configured to cause the UE 115 to transmit the scheduling information, where the data communication is a downlink shared channel communication.

In some examples, to support communicating the scheduling information, the data communication transmission manager 1030 may be configured to cause the UE 115 to receive the scheduling information, where the data communication is an uplink shared channel communication.

A processing system 1020 may include or be a component of one or more chips, systems-on-chips (SoCs), chipsets, packages, components, or devices that individually or collectively constitute or include a processing system. A processing system 1020 may interface with other components of a processing system 1020. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a processing system 1020).

By including or configuring a processing system 1020 for operation in a processing system 1020 as described herein, the processing system 1020 may support techniques for more efficient utilization of communication resources and improved decoding accuracy of SC-MIMO transmissions.

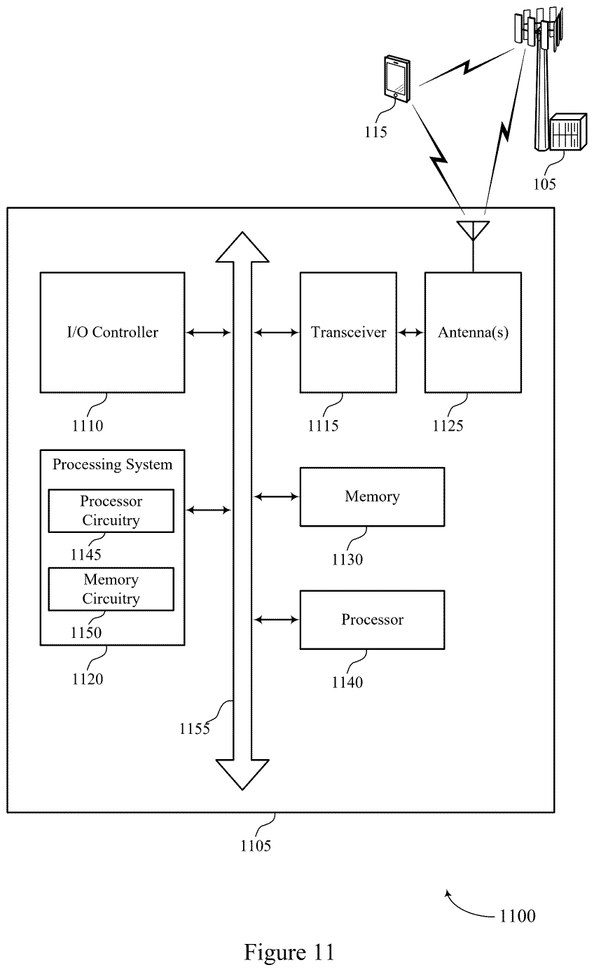

FIG. 11 shows an example of a system 1100 including a device 1105 that supports scheduling of SIC reset code blocks within SC-MIMO transmissions. The device 1105 may be an example of or include components of UE 115. The device 1105 may communicate (such as wirelessly) with one or more other devices (such as network entities 105, UEs 115). The device 1105 may include components for transmitting and receiving communication, which may include a processing system 1120, an input/output (I/O) controller, such as an I/O controller 1110, a transceiver 1115, antenna(s) 1125, a memory 1130, and a processor 1140. Components of the device 1105 may be coupled (such as operatively, communicatively, functionally, electronically, electrically, in electronic communication) a bus 1155.

The transceiver 1115 may support bi-directional communication via antenna(s) 1125, and may support transmission operations, reception operations, or both, as described herein. The transceiver 1115 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1105). The transceiver 1115 may modulate symbols and provide the modulated symbols to antenna(s) 1125 for transmission, and demodulate symbols from signals received using antenna(s) 1125.

The processor 1140 may be a general-purpose processing component that supports various operations (such as applications) of the device 1105. The memory 1130 may be a general-purpose storage component that stores code executable by the processor 1140. Such code may include instructions that, when executed by the processor 1140, cause the device 1105 to perform various functions (such as to support an application of the device 1105). The I/O controller 1110 may manage inputs and outputs for the device 1105, may manage peripherals not integrated into the device 1105, or may represent a physical connection (such as port) to an external peripheral. The processor 1140 may interact with a modem, a keyboard, a mouse, a touchscreen, or other device (such as via I/O controller 1110). In some implementations, a user may interact with the device 1105 via the I/O controller 1110 or via hardware components controlled by the I/O controller 1110.

The processing system 1120 may be an example of a processing system 140 or a processing system 1000. For example, the processing system 1120 may include processor circuitry 1145 and memory circuitry 1150 that stores code, and may be configured to cause the device 1105 to perform operations that support scheduling of SIC reset code blocks within SC-MIMO transmissions. Although the processing system 1120 is illustrated as a separate component, which may involve a separate chip, chipset, or other module, in some implementations, one or more functions described with reference to the processing system 1120 may be supported by or performed by a transceiver 1115, antenna(s) 1125, a processor 1140, memory 1130, or any combination thereof, such that a processing system 1120 may include one or more of a transceiver 1115, antenna(s) 1125, a processor 1140, memory 1130, or any combination thereof.

By including or configuring the processing system 1120 for operation in the device 1105 as described herein, may support techniques for improved communication reliability, more efficient utilization of communication resources, improved coordination between devices via improved decoding accuracy of SC-MIMO transmissions.

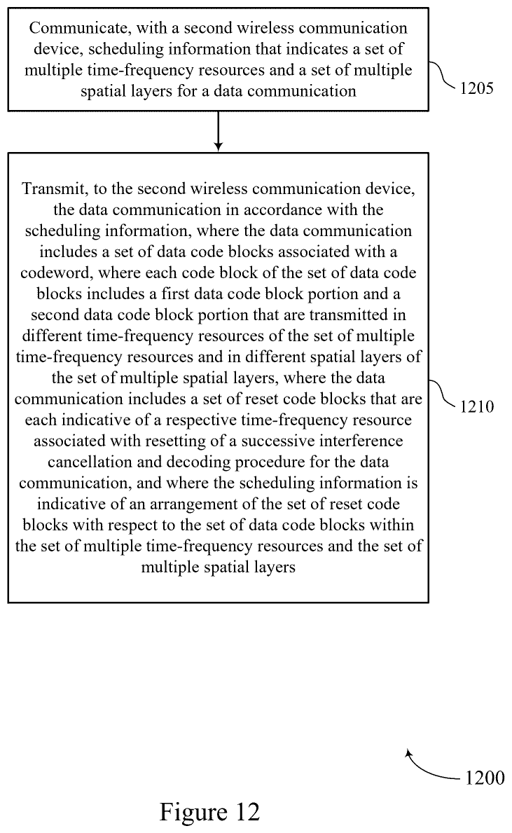

FIG. 12 shows an example of a method 1200 that supports scheduling of SIC reset code blocks within SC-MIMO transmissions. Operations of the method 1200 may be performed by a UE or its components (such as using a processing system configured to cause the UE 115 to perform one or more of the operations) as described herein.

At 1205, the method may include communicating, with a second wireless communication device, scheduling information that indicates a set of multiple time-frequency resources and a set of multiple spatial layers for a data communication. In some examples, aspects of the operations of 1205 may be performed by a scheduling information manager 1025.

At 1210, the method may include transmitting, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers. In some examples, aspects of the operations of 1210 may be performed by a data communication transmission manager 1030.

Implementation examples are described in the following numbered clauses:

Aspect 1: A method for wireless communications at a first wireless communication device, including: communicating, with a second wireless communication device, scheduling information that indicates a set of multiple time-frequency resources and a set of multiple spatial layers for a data communication; and transmitting, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

Aspect 2: The method of aspect 1, further including: receiving, from the second wireless communication device, a negative acknowledgment for a prior transmission of the data communication, where the prior transmission of the data communication used a first density of reset code blocks with respect to data code blocks, where a second density of reset code blocks with respect to data code blocks associated with the arrangement indicated by the scheduling information is greater than the first density based on reception of the negative acknowledgment.

Aspect 3: The method of aspect 2, where transmitting the data communication includes: transmitting, based on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second MCS for the set of data code blocks that is increased with respect to a first MCS used for data code blocks of the prior transmission; a fourth MCS for the set of reset code blocks that is increased with respect to a third MCS used for reset code blocks of the prior transmission; or any combination thereof.

Aspect 4: The method of any of aspects 1 through 3, where transmitting the data communication includes: transmitting a first subset of reset code blocks of the set of reset code blocks in accordance with a first MCS or a first transmission power level; and transmitting a second subset of reset code blocks of the set of reset code blocks in accordance with a second MCS that is lower than the first MCS or a second transmission power level that is higher than the first transmission power level, where the second subset of reset code blocks are each indexed adjacent to multiple data code blocks, and where the first subset of reset code blocks are each indexed adjacent to a single data code block.

Aspect 5: The method of any of aspects 1 through 4, where transmitting the data communication includes: transmitting each reset code block of the set of reset code blocks in accordance with a respective MCS, a respective transmission power level, or a combination thereof, that is based on: a first spacing in data code blocks to a subsequently indexed reset code block, a second spacing in data code blocks to a prior indexed reset code block, or a combination thereof.

Aspect 6: The method of any of aspects 1 through 5, where the scheduling information is indicative of the arrangement via inclusion of an indication of a periodicity of reset code blocks with respect to data code blocks, the periodicity is based on a spacing in data code blocks between successive reset code blocks of the set of reset code blocks.

Aspect 7: The method of any of aspects 1 through 6, where the scheduling information is indicative of the arrangement via inclusion of an indication of respective spacings in data code blocks between successive reset code blocks of the set of reset code blocks.

Aspect 8: The method of aspect 7, where the indication of respective spacing includes a sequence of integers indicative of the respective spacings.

Aspect 9: The method of any of aspects 7 through 8, where the indication of respective spacing includes a set of tuples, for each tuple of the set of tuples a respective first value indicates a respective spacing size in data code blocks and a respective second value indicates a quantity of consecutive spacings between successive reset code blocks having the respective spacing size.

Aspect 10: The method of any of aspects 7 through 9, where the scheduling information indicates the respective spacings with respect to a reference spacing value.

Aspect 11: The method of any of aspects 1 through 10, where the scheduling information is indicative of the arrangement via inclusion of a respective density of reset code blocks with respect to data code blocks for one or more subbands of a set of multiple subbands of the set of multiple time-frequency resources.

Aspect 12: The method of any of aspects 1 through 11, where the scheduling information is indicative of the arrangement via inclusion of a respective density of reset code blocks with respect to data code blocks for each symbol of a set of multiple symbols of the set of multiple time-frequency resources.

Aspect 13: The method of any of aspects 1 through 12, where the arrangement is associated with a density of reset code blocks with respect to data code blocks, and the density is based on a channel delay spread associated with a communication channel used to transmit the data communication.

Aspect 14: The method of any of aspects 1 through 13, where communicating the scheduling information includes: transmitting the scheduling information, where the data communication is a downlink shared channel communication.

Aspect 15: The method of any of aspects 1 through 13, where communicating the scheduling information includes: receiving the scheduling information, where the data communication is an uplink shared channel communication.

Aspect 16: A first wireless communication device, including: one or more memories storing processor-executable code; and one or more processors coupled with the one or more memories and individually or collectively operable to execute the code to cause the first wireless communication device to: communicate, with a second wireless communication device, scheduling information that indicates a set of multiple time-frequency resources and a set of multiple spatial layers for a data communication; and transmit, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

Aspect 17: The first wireless communication device of aspect 16, where the one or more processors are individually or collectively further operable to execute the code to cause the first wireless communication device to: receive, from the second wireless communication device, a negative acknowledgment for a prior transmission of the data communication, where the prior transmission of the data communication used a first density of reset code blocks with respect to data code blocks, where a second density of reset code blocks with respect to data code blocks associated with the arrangement indicated by the scheduling information is greater than the first density based on reception of the negative acknowledgment.

Aspect 18: The first wireless communication device of aspect 17, where, to transmit the data communication, the one or more processors are individually or collectively operable to execute the code to cause the first wireless communication device to: transmit, based on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second MCS for the set of data code blocks that is increased with respect to a first MCS used for data code blocks of the prior transmission; a fourth MCS for the set of reset code blocks that is increased with respect to a third MCS used for reset code blocks of the prior transmission; or any combination thereof.

Aspect 19: The first wireless communication device of any of aspects 16 through 18, where, to transmit the data communication, the one or more processors are individually or collectively operable to execute the code to cause the first wireless communication device to: transmit a first subset of reset code blocks of the set of reset code blocks in accordance with a first MCS or a first transmission power level; and transmit a second subset of reset code blocks of the set of reset code blocks in accordance with a second MCS that is lower than the first MCS or a second transmission power level that is higher than the first transmission power level, where the second subset of reset code blocks are each indexed adjacent to multiple data code blocks, and where the first subset of reset code blocks are each indexed adjacent to a single data code block.

Aspect 20: The first wireless communication device of any of aspects 16 through 19, where, to transmit the data communication, the one or more processors are individually or collectively operable to execute the code to cause the first wireless communication device to: transmit each reset code block of the set of reset code blocks in accordance with a respective MCS, a respective transmission power level, or a combination thereof, that is based on: a first spacing in data code blocks to a subsequently indexed reset code block, a second spacing in data code blocks to a prior indexed reset code block, or a combination thereof.

Aspect 21: The first wireless communication device of any of aspects 16 through 20, where the scheduling information is indicative of the arrangement via inclusion of an indication of a periodicity of reset code blocks with respect to data code blocks, the periodicity is based on a spacing in data code blocks between successive reset code blocks of the set of reset code blocks.

Aspect 22: The first wireless communication device of any of aspects 16 through 21, where the scheduling information is indicative of the arrangement via inclusion of an indication of respective spacings in data code blocks between successive reset code blocks of the set of reset code blocks.

Aspect 23: The first wireless communication device of aspect 22, where: the indication of respective spacing includes a sequence of integers indicative of the respective spacings.

Aspect 24: The first wireless communication device of any of aspects 22 through 23, where: the indication of respective spacing includes a set of tuples, for each tuple of the set of tuples a respective first value indicates a respective spacing size in data code blocks and a respective second value indicates a quantity of consecutive spacings between successive reset code blocks having the respective spacing size.

Aspect 25: The first wireless communication device of any of aspects 22 through 24, where the scheduling information indicates the respective spacings with respect to a reference spacing value.

Aspect 26: The first wireless communication device of any of aspects 16 through 25, where the scheduling information is indicative of the arrangement via inclusion of a respective density of reset code blocks with respect to data code blocks for one or more subbands of a set of multiple subbands of the set of multiple time-frequency resources.

Aspect 27: The first wireless communication device of any of aspects 16 through 26, where the scheduling information is indicative of the arrangement via inclusion of a respective density of reset code blocks with respect to data code blocks for each symbol of a set of multiple symbols of the set of multiple time-frequency resources.

Aspect 28: The first wireless communication device of any of aspects 16 through 27, where the arrangement is associated with a density of reset code blocks with respect to data code blocks, and the density is based on a channel delay spread associated with a communication channel used to transmit the data communication.

Aspect 29: The first wireless communication device of any of aspects 16 through 28, where, to communicate the scheduling information, the one or more processors are individually or collectively operable to execute the code to cause the first wireless communication device to: transmit the scheduling information, where the data communication is a downlink shared channel communication.

Aspect 30: The first wireless communication device of any of aspects 16 through 28, where, to communicate the scheduling information, the one or more processors are individually or collectively operable to execute the code to cause the first wireless communication device to: receive the scheduling information, where the data communication is an uplink shared channel communication.

Aspect 31: A non-transitory computer-readable medium storing code for wireless communications, the code including instructions executable by one or more processors to: communicate, with a second wireless communication device, scheduling information that indicates a set of multiple time-frequency resources and a set of multiple spatial layers for a data communication; and transmit, to the second wireless communication device, the data communication in accordance with the scheduling information, where the data communication includes a set of data code blocks associated with a codeword, where each code block of the set of data code blocks includes a first data code block portion and a second data code block portion that are transmitted in different time-frequency resources of the set of multiple time-frequency resources and in different spatial layers of the set of multiple spatial layers, where the data communication includes a set of reset code blocks that are each indicative of a respective time-frequency resource associated with resetting of a successive interference cancellation and decoding procedure for the data communication, and where the scheduling information is indicative of an arrangement of the set of reset code blocks with respect to the set of data code blocks within the set of multiple time-frequency resources and the set of multiple spatial layers.

Aspect 32: The non-transitory computer-readable medium of aspect 31, where the instructions are further executable by the one or more processors to: receive, from the second wireless communication device, a negative acknowledgment for a prior transmission of the data communication, where the prior transmission of the data communication used a first density of reset code blocks with respect to data code blocks, where a second density of reset code blocks with respect to data code blocks associated with the arrangement indicated by the scheduling information is greater than the first density based on reception of the negative acknowledgment.

Aspect 33: The non-transitory computer-readable medium of aspect 32, where the instructions to transmit the data communication are executable by the one or more processors to: transmit, based on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second MCS for the set of data code blocks that is increased with respect to a first MCS used for data code blocks of the prior transmission; a fourth MCS for the set of reset code blocks that is increased with respect to a third MCS used for reset code blocks of the prior transmission; or any combination thereof.

Aspect 34: The non-transitory computer-readable medium of any of aspects 31 through 33, where the instructions to transmit the data communication are executable by the one or more processors to: transmit a first subset of reset code blocks of the set of reset code blocks in accordance with a first MCS or a first transmission power level; and transmit a second subset of reset code blocks of the set of reset code blocks in accordance with a second MCS that is lower than the first MCS or a second transmission power level that is higher than the first transmission power level, where the second subset of reset code blocks are each indexed adjacent to multiple data code blocks, and where the first subset of reset code blocks are each indexed adjacent to a single data code block.

Aspect 35: The non-transitory computer-readable medium of any of aspects 31 through 34, where the instructions to transmit the data communication are executable by the one or more processors to: transmit each reset code block of the set of reset code blocks in accordance with a respective MCS, a respective transmission power level, or a combination thereof, that is based on: a first spacing in data code blocks to a subsequently indexed reset code block, a second spacing in data code blocks to a prior indexed reset code block, or a combination thereof.

Aspect 36: The non-transitory computer-readable medium of any of aspects 31 through 35, where the scheduling information is indicative of the arrangement via inclusion of an indication of a periodicity of reset code blocks with respect to data code blocks, the periodicity is based on a spacing in data code blocks between successive reset code blocks of the set of reset code blocks.

Aspect 37: The non-transitory computer-readable medium of any of aspects 31 through 36, where the scheduling information is indicative of the arrangement via inclusion of an indication of respective spacings in data code blocks between successive reset code blocks of the set of reset code blocks.

Aspect 38: The non-transitory computer-readable medium of aspect 37, where: the indication of respective spacing includes a sequence of integers indicative of the respective spacings.

Aspect 39: The non-transitory computer-readable medium of any of aspects 37 through 38, where: the indication of respective spacing includes a set of tuples, for each tuple of the set of tuples a respective first value indicates a respective spacing size in data code blocks and a respective second value indicates a quantity of consecutive spacings between successive reset code blocks having the respective spacing size.

Aspect 40: The non-transitory computer-readable medium of any of aspects 37 through 39, where the scheduling information indicates the respective spacings with respect to a reference spacing value.

Aspect 41: The non-transitory computer-readable medium of any of aspects 31 through 40, where the scheduling information is indicative of the arrangement via inclusion of a respective density of reset code blocks with respect to data code blocks for one or more subbands of a set of multiple subbands of the set of multiple time-frequency resources.

Aspect 42: The non-transitory computer-readable medium of any of aspects 31 through 41, where the scheduling information is indicative of the arrangement via inclusion of a respective density of reset code blocks with respect to data code blocks for each symbol of a set of multiple symbols of the set of multiple time-frequency resources.

Aspect 43: The non-transitory computer-readable medium of any of aspects 31 through 42, where the arrangement is associated with a density of reset code blocks with respect to data code blocks, and the density is based on a channel delay spread associated with a communication channel used to transmit the data communication.

Aspect 44: The non-transitory computer-readable medium of any of aspects 31 through 43, where the instructions to communicate the scheduling information are executable by the one or more processors to: transmit the scheduling information, where the data communication is a downlink shared channel communication.

Aspect 45: The non-transitory computer-readable medium of any of aspects 31 through 44, where the instructions to communicate the scheduling information are executable by the one or more processors to: receive the scheduling information, where the data communication is an uplink shared channel communication.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code) stored in memory circuitry or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories storing processor-executable code; and
one or more processors coupled with the one or more memories and individually or collectively operable to execute the code to cause the first wireless communication device to:
communicate, with a second wireless communication device, scheduling information that indicates a plurality of time-frequency resources and a plurality of spatial layers for a data communication; and
transmit, to the second wireless communication device, the data communication in accordance with the scheduling information, wherein the data communication comprises a set of data code blocks associated with a codeword, wherein each code block of the set of data code blocks comprises a first data code block portion and a second data code block portion that are transmitted in different time-frequency resources of the plurality of time-frequency resources and in different spatial layers of the plurality of spatial layers, wherein the data communication comprises a set of reset code blocks that are each indicative of a respective time-frequency resource associated with resetting of a successive interference cancellation and decoding procedure for the data communication, and wherein the scheduling information is indicative of an arrangement of the set of reset code blocks with respect to the set of data code blocks within the plurality of time-frequency resources and the plurality of spatial layers.

2. The first wireless communication device of claim 1, wherein the one or more processors are individually or collectively further operable to execute the code to cause the first wireless communication device to:
receive, from the second wireless communication device, a negative acknowledgment for a prior transmission of the data communication, wherein the prior transmission of the data communication used a first density of reset code blocks with respect to data code blocks, wherein a second density of reset code blocks with respect to data code blocks associated with the arrangement indicated by the scheduling information is greater than the first density based at least in part on reception of the negative acknowledgment.

3. The first wireless communication device of claim 2, wherein, to transmit the data communication, the one or more processors are individually or collectively operable to execute the code to cause the first wireless communication device to:
transmit, based at least in part on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second modulation and coding scheme for the set of data code blocks that is increased with respect to a first modulation and coding scheme used for data code blocks of the prior transmission; a fourth modulation and coding scheme for the set of reset code blocks that is increased with respect to a third modulation and coding scheme used for reset code blocks of the prior transmission; or any combination thereof.

4. The first wireless communication device of claim 1, wherein, to transmit the data communication, the one or more processors are individually or collectively operable to execute the code to cause the first wireless communication device to:
transmit a first subset of reset code blocks of the set of reset code blocks in accordance with a first modulation and coding scheme or a first transmission power level; and
transmit a second subset of reset code blocks of the set of reset code blocks in accordance with a second modulation and coding scheme that is lower than the first modulation and coding scheme or a second transmission power level that is higher than the first transmission power level, wherein the second subset of reset code blocks are each indexed adjacent to multiple data code blocks, and wherein the first subset of reset code blocks are each indexed adjacent to a single data code block.

5. The first wireless communication device of claim 1, wherein, to transmit the data communication, the one or more processors are individually or collectively operable to execute the code to cause the first wireless communication device to:
transmit each reset code block of the set of reset code blocks in accordance with a respective modulation and coding scheme, a respective transmission power level, or a combination thereof, that is based at least in part on: a first spacing in data code blocks to a subsequently indexed reset code block, a second spacing in data code blocks to a prior indexed reset code block, or a combination thereof.

6. The first wireless communication device of claim 1, wherein:
the scheduling information is indicative of the arrangement via inclusion of an indication of a periodicity of reset code blocks with respect to data code blocks, and
the periodicity is based at least in part on a spacing in data code blocks between successive reset code blocks of the set of reset code blocks.

7. The first wireless communication device of claim 1, wherein the scheduling information is indicative of the arrangement via inclusion of an indication of respective spacings in data code blocks between successive reset code blocks of the set of reset code blocks.

8. The first wireless communication device of claim 7, wherein:
the indication of respective spacing comprises a sequence of integers indicative of the respective spacings.

9. The first wireless communication device of claim 7, wherein:
the indication of respective spacing comprises a set of tuples, and
for each tuple of the set of tuples a respective first value indicates a respective spacing size in data code blocks and a respective second value indicates a quantity of consecutive spacings between successive reset code blocks having the respective spacing size.

10. The first wireless communication device of claim 7, wherein the scheduling information indicates the respective spacings with respect to a reference spacing value.

11. The first wireless communication device of claim 1, wherein the scheduling information is indicative of the arrangement via inclusion of a respective density of reset code blocks with respect to data code blocks for one or more subbands of a plurality of subbands of the plurality of time-frequency resources.

12. The first wireless communication device of claim 1, wherein the scheduling information is indicative of the arrangement via inclusion of a respective density of reset code blocks with respect to data code blocks for each symbol of a plurality of symbols of the plurality of time-frequency resources.

13. The first wireless communication device of claim 1, wherein:
the arrangement is associated with a density of reset code blocks with respect to data code blocks, and
the density is based at least in part on a channel delay spread associated with a communication channel used to transmit the data communication.

14. The first wireless communication device of claim 1, wherein, to communicate the scheduling information, the one or more processors are individually or collectively operable to execute the code to cause the first wireless communication device to:
transmit the scheduling information, wherein the data communication is a downlink shared channel communication.

15. The first wireless communication device of claim 1, wherein, to communicate the scheduling information, the one or more processors are individually or collectively operable to execute the code to cause the first wireless communication device to:
receive the scheduling information, wherein the data communication is an uplink shared channel communication.

16. A method for wireless communications at a first wireless communication device, comprising:
communicating, with a second wireless communication device, scheduling information that indicates a plurality of time-frequency resources and a plurality of spatial layers for a data communication; and
transmitting, to the second wireless communication device, the data communication in accordance with the scheduling information, wherein the data communication comprises a set of data code blocks associated with a codeword, wherein each code block of the set of data code blocks comprises a first data code block portion and a second data code block portion that are transmitted in different time-frequency resources of the plurality of time-frequency resources and in different spatial layers of the plurality of spatial layers, wherein the data communication comprises a set of reset code blocks that are each indicative of a respective time-frequency resource associated with resetting of a successive interference cancellation and decoding procedure for the data communication, and wherein the scheduling information is indicative of an arrangement of the set of reset code blocks with respect to the set of data code blocks within the plurality of time-frequency resources and the plurality of spatial layers.

17. The method of claim 16, further comprising:
receiving, from the second wireless communication device, a negative acknowledgment for a prior transmission of the data communication, wherein the prior transmission of the data communication used a first density of reset code blocks with respect to data code blocks, wherein a second density of reset code blocks with respect to data code blocks associated with the arrangement indicated by the scheduling information is greater than the first density based at least in part on reception of the negative acknowledgment.

18. The method of claim 17, wherein transmitting the data communication comprises:
transmitting, based at least in part on the prior transmission of the data communication using a first quantity of time-frequency-spatial resources, the data communication using a second quantity of time-frequency spatial resources, the data communication in accordance with: a first puncturing rate for the set of data code blocks; a second puncturing rate for the set of reset code blocks; a second modulation and coding scheme for the set of data code blocks that is increased with respect to a first modulation and coding scheme used for data code blocks of the prior transmission; a fourth modulation and coding scheme for the set of reset code blocks that is increased with respect to a third modulation and coding scheme used for reset code blocks of the prior transmission; or any combination thereof.

19. The method of claim 16, wherein transmitting the data communication comprises:
transmitting a first subset of reset code blocks of the set of reset code blocks in accordance with a first modulation and coding scheme or a first transmission power level; and
transmitting a second subset of reset code blocks of the set of reset code blocks in accordance with a second modulation and coding scheme that is lower than the first modulation and coding scheme or a second transmission power level that is higher than the first transmission power level, wherein the second subset of reset code blocks are each indexed adjacent to multiple data code blocks, and wherein the first subset of reset code blocks are each indexed adjacent to a single data code block.

20. A non-transitory computer-readable medium storing code for wireless communications, the code comprising instructions executable by one or more processors to:
communicate, with a second wireless communication device, scheduling information that indicates a plurality of time-frequency resources and a plurality of spatial layers for a data communication; and
transmit, to the second wireless communication device, the data communication in accordance with the scheduling information, wherein the data communication comprises a set of data code blocks associated with a codeword, wherein each code block of the set of data code blocks comprises a first data code block portion and a second data code block portion that are transmitted in different time-frequency resources of the plurality of time-frequency resources and in different spatial layers of the plurality of spatial layers, wherein the data communication comprises a set of reset code blocks that are each indicative of a respective time-frequency resource associated with resetting of a successive interference cancellation and decoding procedure for the data communication, and wherein the scheduling information is indicative of an arrangement of the set of reset code blocks with respect to the set of data code blocks within the plurality of time-frequency resources and the plurality of spatial layers.
